(19) United States
(12) Patent Application Publication
(10) Pub. No.: US 2004/0044436 A1
(43) Pub. Date: Mar. 4, 2004

(54) Process and installation for separating plastics, according to type, from recycled plastic mixtures

(76) Inventors: Frank Arleth, Elsdorf (DE); Thomas Koch, Koln (DE); Mirko Winter, Chemnitz (DE); Bert Handschick, Zittau (DE); Ernst Peter Dietrich-Troeltsch, Waldenbuch (DE)

Correspondence Address: Aslan Baghdadi, Shaw Pittman, 1650 Tysons Boulevard, Mc Lean, VA, 22102, US

(21) Appl. No.: 10/332,502

(22) PCT Filed: Jul. 6, 2001
(86) PCT No.: PCT/EP01/07742

(30) Foreign Application Priority Data
Jul. 10, 2000 (DE) 100 33 231.5
Mar. 29, 2001 (DE) 101 15 781.9

(51) Int. Cl. G06F 7/00

(52) U.S. Cl. 700/224

(57) ABSTRACT

The present invention relates to a process by which plastics are separated from recycled plastic mixtures according to type, whereby the plastic parts freed from metals are taken on fast moving conveyor belts isolated as a fine, light and/or coarse material and the plastic parts to be selected are removed from the plastic flow in at least one optomechanical sorting device of activatable ejectors. With the goal of providing clean materials cheaply for further recycling all those plastic parts that do not belong to the predominant group of materials in the plastic flow are actively separated from the plastic part flow, in an initial process step (5, 5′, 6, 6′) at minimum one optomechanical sorting device, using individually controlled ejectors (for example nozzles) and in a second process step (56, 57; 7; 8) from one of the secondary plastic flows at, at least, one other optomechanical sorting device the predominant plastic parts contained in the plastic flow or a part definable according to optically identifiable criteria of the same is actively separated.

The present invention relates to a process by which plastics are separated from recycled plastic mixtures according to type, whereby the plastic parts, freed from metals, are taken on fast moving conveyor belts isolated as a fine, light and/or coarse material. The plastic parts to be selected are removed from the plastic flow in at least one optomechanical sorting device of activatable ejectors. The plastic parts to be selected and their position are determined by optical sensors and similar sorting logic (stored program control unit) in the optomechanical sorting device. The time and the duration of the activation of the ejector(s) located in the plastic flow path of each selected plastic part are calculated and finally the identified ejector(s) are activated to change the path of the selected plastic parts.

Such a plastic recycling installation for plastic waste is already well known from EP 578 727 B1. Following an expensive process classifying the parts, removing metals, isolating clusters consisting of several parts, removing small and heavy parts, as well as, small and large films and similar things, a material of isolated bottles made from various plastics is made available for sorting using optomechanical sorting devices.

In preparation for this sorting event the bottles with special fittings are deliberately spread over the entire width of the conveyor belts or the so-called acceleration strips. Using inclined sliding surfaces with several sliding paths that run parallel to the sliding direction and that have a channel shaped cross section, the bottles are placed in lines on fast moving conveyor belts. At least one camera is placed over the bottles lined up on the conveyor belts that identifies each line and that with the help of sorting logic (stored program control unit) that uses comparative parameters (for example frequency curves of various wave lengths of the rays reflected by each material) assigned to each type of plastic. The position of plastic parts, chosen through comparison, is identified at the same time.

Should a specific plastic be passed forward for ejection, based on the respective position of the analyzed part, a specific group of nozzles that function as ejectors are discharged with compressed air over a calculated short time. The nozzles of this group deliver an impulse to all parts that pass the nozzles in that time period and lead the parts on a different path to another collection area separated from the collection area for the plastics that are not being ejected.

In the initial step of an example, plastic that to a large extent is contained in the mixture of plastic bottles and that is intended for recycling, namely PET, is actively ejected using compressed-air jets. This means that many groups of nozzles are actively ejecting for a long time. In this manner, besides the parts or bottles intended for ejection, much material not intended for ejection which is not desirable in the target material, is also removed. The ejected material is dirty and has limited use for recycling. Reducing the size of the nozzle group, which theoretically could improve the sorting results, is strictly limited not only by the average size of the bottles.

The present invention suggests a process for sorting and an installation for sorting plastic mixtures which facilitates the dependable preparation of each plastic that can be reprocessed with sufficient cleanliness and at a justifiable cost.

The problem is solved through the characteristics of the method according to claim 1. The sorting event, that consists of two different processing steps, facilitates, in the initial process step, the segregation of a considerable amount of the plastic that is the most different from the anticipated plastic types in the plastic flow but which does not belong to the predominant type of plastic. Experiments have shown that the share of predominant material found among the parts in the plastic flow is small among the ejected, or as the case may be, separated material. Furthermore, the remaining material is already relatively clean.

Following a new distribution of the remaining plastic flow, all or one definable part of plastic parts which belong to the now clearly predominant type of material, is actively separated in the second processing step. The possibility that parts made from different plastic types are segregated at this point is very small.

It is important that the plastics to be re-used in a later recycling process are of high quality. The present invention facilitates this.

The division of the initial process step into two subsequent sorting steps which is performed on two different conveyor belts placed in rows next to each other with two optomechanical sorting devices, which are fitted with a corresponding programmed sorting logic, in accordance with patent claim 2, leads to a further, significant improvement of the sorting results of the remaining material.

Good quality products made from the re-used plastic is achieved when, in accordance with patent claim 3, plastic parts are ejected during the second step of the process, in several consecutive sorting steps, for example, in accordance with a color criteria.

Due to the exceptional value of transparent plastic, the modification in accordance with patent claim 4 is particularly advantageous.

If a mixture of plastic consists predominantly of two almost equal parts of different materials, it is recommended to use the modification in accordance with patent claim 5. In the initial step of the process all the plastic that do not fall within the two-part material are firstly segregated. This segregation should occur analogously to patent claim 2, preferably, in two consecutive corresponding sorting steps. The separation of the then clean existing two-part material also occurs according to the two-step sorting The method according to claim

2. The two-part material can then be assessed as a plastic flow that, in accordance with patent claim 1, is subjected to a negative and at least one positive sorting event.

Preferably, the material that either requires particular cleanliness for further processing or the material that has the smaller content of the two-part material is actively segregated.

Plastic mixtures that predominantly consist of PET and/or PE material are removed, preferably in accordance with the process as defined in patent claim 6. The remaining plastic materials from the remaining plastic flow could selectively be removed in separate process steps later.

Should the processed plastic mixture regularly contain hollow articles, which were inserted as cartridges, it is required to segregate this material from the plastic flow before the start of the sorting process, if possible, because the silicone could interfere with the continuing steps (patent claim 7).

The use of only material criteria usually makes the reliable recognition of cartridges impossible. In this case, therefore, the selection criteria is the geometric dimensions and proportions of these cartridges as stored geometric reference area of the sorting logic, in accordance with patent claim 8.

The preparation of the plastic parts of a supplied plastic flow that mainly consists of hollow articles in accordance with the characteristics of patent claim 9, improves the sorting results significantly. The perforated hollow articles basically retain the flat shape achieved through the deformation. The air resistance of the deformed plastic parts, caused by the speed of the conveyor belt, is limited by the reduced cross section. The flattened plastic parts also provide the ejector nozzle better contact surfaces. The plastic parts barely change position, relative to the conveyor belt, between the optical sensors and the nozzles, ensuring a good sorting result.

The installation in accordance with patent claim 10, with which the method according to claims 1 or 2 can also be realized, is characterized by a special compactness and by a high variability of the necessary sorting processes.

The sorting device arrangement for the cartridges, in accordance with patent claim 11, is used to keep away the interfering silicone from all separated plastic.

The use of a perforator, in accordance with patent claim 12, in connection with the use of compacting agents (rollers or compression pressers) on the plastic parts, optimizes the operation of all sorting devices.

The invention is described in further detail below using an implementation example. The accompanying drawings show:

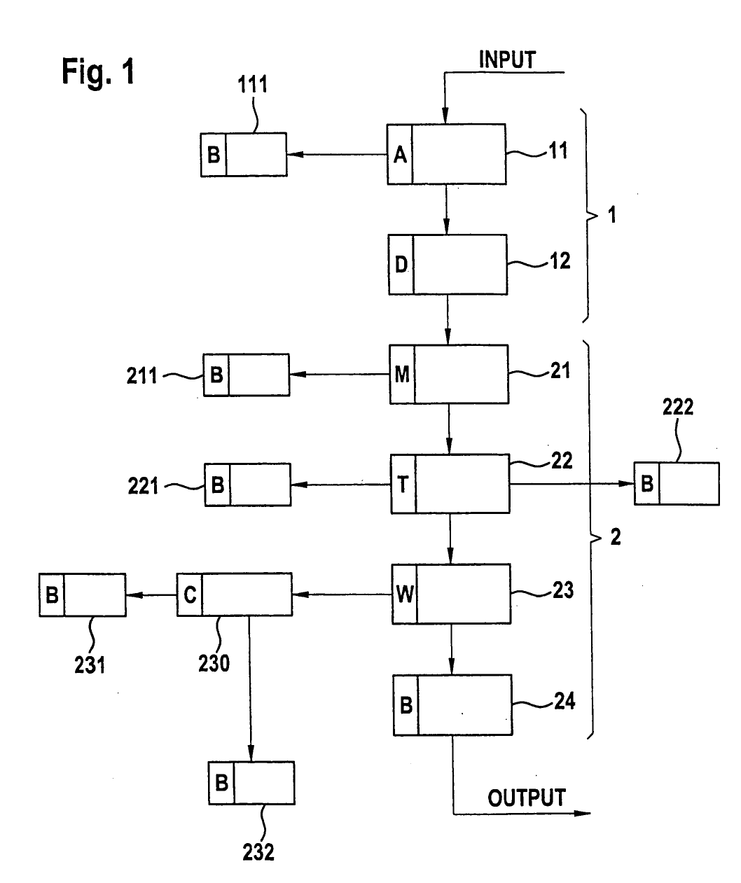

FIG. 1 a schematic representation of the preparation of the sorting flow for the sorting process,

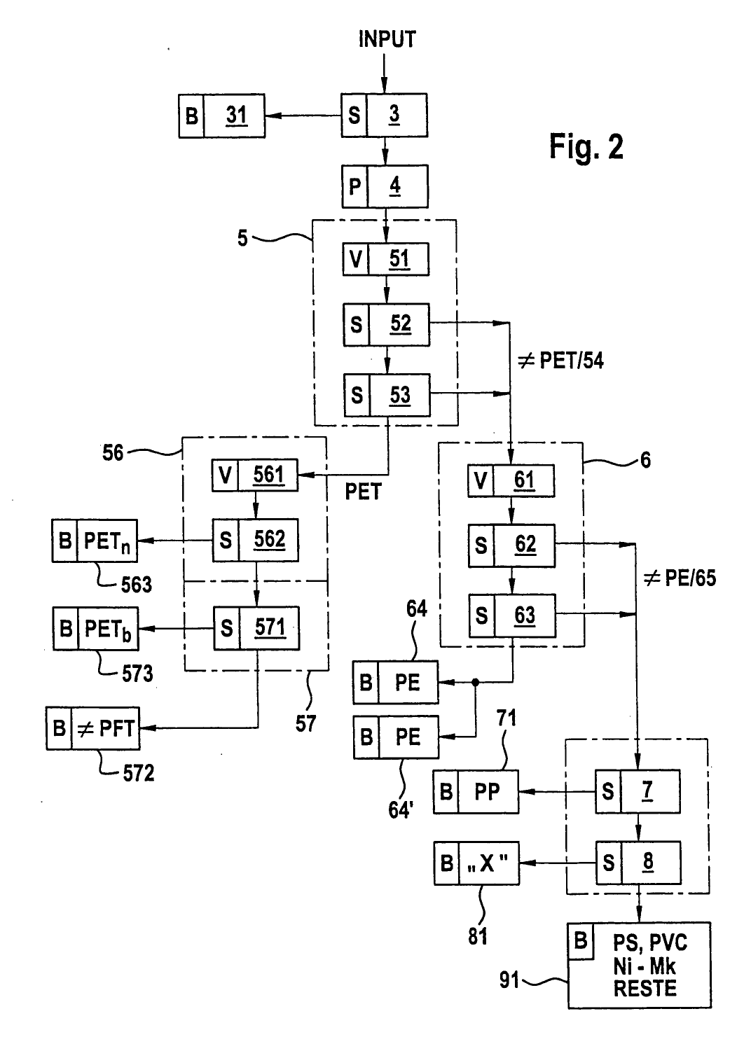

FIG. 2 a schematic representation of one variation of the sorting process until the provision of separated plastic for, predominantly materially, further processing,

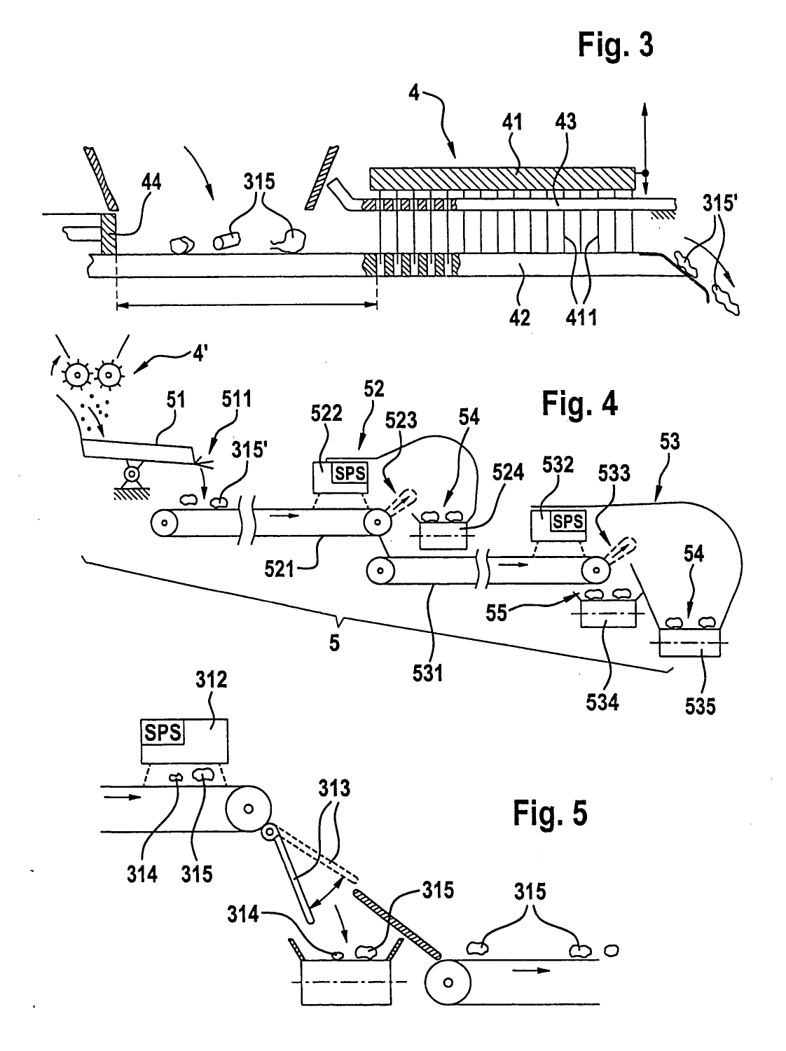

FIG. 3 a schematic representation of the perforation event with up and down movable knife encasement and stripper,

FIG. 4 a schematic representation of a sorting system with two subsequently arranged sorting devices with the same function,

FIG. 5 a schematic representation of the sorting device for cartridges (or metal parts),

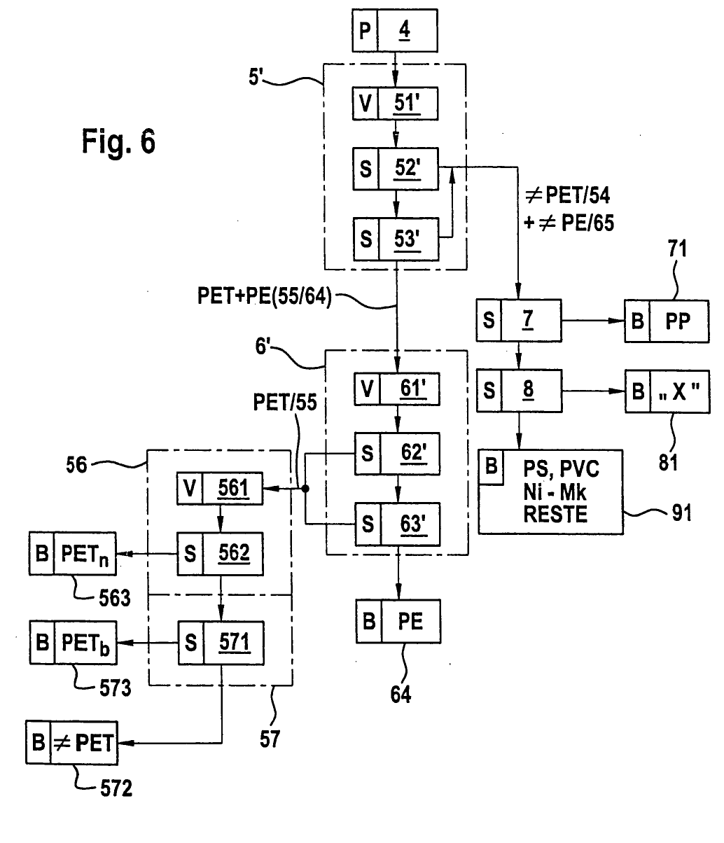

FIG. 6 a sorting system for plastic containers basically consisting of equal parts of PE and PET plastics and

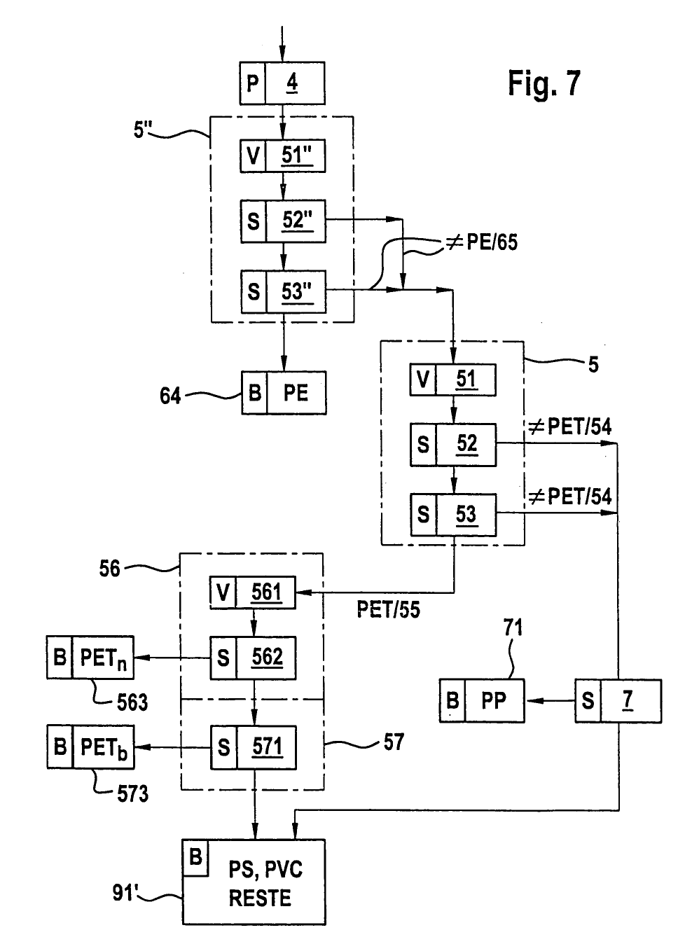

FIG. 7 another variation of the sorting installation for recycling of plastic mixtures consisting mainly of PE.

The detailed description of the principles of the present invention will use a plastic mixture containing packaging waste, which is collected from households among the population in the so-called yellow sacks.

The content of these yellow sacks is firstly pressed into bales to facilitate transportation and storage and is made available for further treatment in this form at the central treatment installations.

Referring to FIG. 1, the treatment installation for this plastic mixture starts in the area of the bale release 1 with the removal of the string from the bales in the area of a buffer 11 and the isolation of the plastic parts in the bale at the bale releaser 12, which also serves a metering function. The string is stored in a special collection container 111 for re-use.

In an initial operation step of the pre-sorting event 2 in a metal segregator 21, the metal parts are identified with the help of common magnetic or inductive parameters by a detector and removed via a waste cover together with the parts of the plastic flow. The principle of the segregation in principle corresponds to the segregation described later in connection with FIG. 5 with the exception of the type of sensors used.

The plastic flow that is now free of metal parts is passed through a drum separator 22 (also called a screening drum segregator T). There, in an initial step, the small parts are segregated as fine material and stored in a container 221. The cross section dimensions of the small parts are 40 mm maximum.

In a final section the parts with a cross section smaller than 250 mm to 350 mm are separated. The larger parts are described here as coarse material. Initially, this material remains within the drum separator 22 but is finally axially removed from the drum separator and stored in the container 222.

The medium sized segregated material is now passed through an air separator 23. In this air separator 23 light material such as paper, thin foils and light fabric is segregated and stored in a container 231. In the segregator 230 these light material are freed from dry dust at the same time. The dry dust is collected in the container 232.

The plastic parts remaining in the plastic flow after the air separator 23 are predominantly bottle shaped hollow articles or any differently shaped plastic parts that are led to further sorting. The interim storage of those parts occurs in a container that takes the form of a buffer 24.

FIG. 2 shows the further separation scheme of each plastic type after extraction from the buffer 24. First, the hollow articles that serve as cartridges 314 (see FIG. 5) and that often contain substances based on silicone, which would interfere in the present processing events, are segregated from the process in the sorting device 3.

The plastic flow that was led to the sorting device 3 is identified by sensors 312 as digitized pictures (see FIG. 5), preferably by digital cameras. In a stored program control unit (SPS) or in a suitable interpretation device, several possible views and shapes of well-known cartridges are stored as a reference area. The stored program control unit or interpretation device compares the pictures taken by the camera of the cartridges 314 in their essential proportion with the existing parameters of known cartridges in the storage unit.

If similarity is determined by the stored program control unit, the ejector 313 is shortly activated, if the identified cartridge 314 is located in its effective area, and the cartridge 314 is joined with the part of the closest neighboring plastic flow (315) on a separate conveyor belt.

In this case, the plastic flow now freed from cartridges 314 that in this case predominantly consists of hollow plastic articles 315, is led to the perforator 4, an embodiment of which is schematically shown in FIG. 3. This perforator 4 has knives or needles 411, which are held in a knife encasement 41 and which regularly move up and down. They perforate the plastic parts 315 and deform them to irregular largely flat shapes with little air resistance allowing them to lie still, not rolling, on the conveyor belt 521, 531 of the sorting device 52, 53 ensuring that the air jet of the ejector nozzle 523 or as the case may be 533 of the sorting device 52, 53 reaches them, facilitating their removal.

The perforator 4 needles 411 preferably are attached to a perforated steady plate 42 and a stripper 43, as is already well known. A feeder 44 ensures the placement of a new body of plastic 315 under the needle group 411 and the removal of the already perforated plastic parts 315′. It is appropriate to shape the needles 411 in such a way that when the needles perforate the surface of the plastic of a hollow article 315 the air reliably escapes and in such a way that recesses on the needle support the deformation of the hollow article.

Instead of the up and down moving knife encasement, naturally other tools may be used to perforate and deform. A perforator 4′ fitted with spiked rollers, as schematically shown in FIG. 4, is also suited for this process, in particular for high flow rate throughput.

The plastic parts 315 perforated in this manner, are placed in a distribution channel 51 (also 61, 561), which performs a shaking movement and which leans in the transport direction, and they are isolated further and evenly distributed on the fast running conveyor belt 521, 531 (up to 150 m/min.) (see FIG. 4). It has proven to be advantageous to add short bars 511 facing in different directions at the ejection point of the swinging distribution channel. These bars 511 also facilitate an even distribution of the plastic parts 315, 315′ on the following conveyor belts 521.

In the final areas of the conveyor belts 521, 531 where the plastic parts 315′ have reliably adjusted to the speed of each conveyor belt it is preferable that sensors 522, 532 or photo detectors are attached above the plastic flow. These sensors 522, 532 or photo detectors are able to identify the reflected signals from parts of the plastic flow and to compare them to stored data about known plastics, which is based on the different defined positions. Should a (extensive) correspondence to a plastic, destined to be ejected, be determined, the signal processor or the stored program control unit (SPS), which we have defined as the sorting logic in the following, calculates the time and duration of the control of the ejection nozzle(s) on the basis of the movement parameter of the conveyor belt.

To perform the comparison resulting in the determination of each plastic type, _{“}optically identifiable criteria”, namely rays of different wavelengths could be evaluated using _{“}sorting logic”. These wavelengths range from the so-called near infrared (NIR)—with wavelengths reaching from between 0.7 ηm to 2.5 ηm—to visible light with significantly shorter wavelengths.

It is also possible to identify and evaluate light which has been exited by high-level radiation on plastic in order to allocate the plastic to one or another material grouping, using spectrum analysis.

For the ejection—the _{“}active separation”—of the identified plastic, ejectors in the form of ejector nozzles 523, 533 controlled by magnetic valves are usually described and used in practice.

Naturally, it is possible to use purely mechanical ejector nozzles (controlled plunger, flap or end stops) instead of these pneumatic ejector nozzles as long as the often grounded ejectors can be activated in the short time available.

The demands on the ejector are high at the speeds the plastic parts reach while leaving the conveyor belt, which could be faster than 2.5 m/s.

To simplify matters the term _{“}optomechanical sorting device” has been used below to describe one of the sensors from a sorting logic and from sorting setups consisting of controllable mechanical or pneumatic ejectors, as described above.

In principle, the course of the sorting event usually complies with the average composition of the plastic flow to be processed. In the explanation below of the sorting process, it is assumed that the plastic flow currently consists mainly of PET material. The PE material content today, is usually equally or similarly extensive in the plastic flow.

The examples described below are based on this current state of affairs.

We continue our pursuit of the sorting process with reference to FIGS. 2 and 4. In the final area of the conveyor belts 521, 531, where the plastic parts 315′ have adjusted to the speed of the conveyor belt, sensors 522, 532 are fitted above the plastic flow, which identify the position and type of each plastic material, while being illuminated.

From the resulting signals and from the respective locations of the chosen plastic bodies and the speed of the conveyor belt 521, 531, using sorting logic, an electronic control unit SPS identifies the respective ejector nozzle 523, 533 and the moment of its activation for the ejection or the active separation of the chosen plastic part.

In the installation, as schematically shown in FIG. 2, in an initial sorting system 5 (initial process step) of the sorting device 52, all those plastics that do not predominantly consist of PET material are separated via ejection nozzles 523 (please compare to FIG. 3). They are brought to a collection point by the conveyor belt 524.

At a second sorting device 53, at the conveyor belt 531, the plastic parts are identified by sensors 532 and the plastic parts to be chosen are identified using the same sorting program as used at the sorting device 52. In this manner, the plastics that do not belong to the PET material group, namely the _{“}non-PET” materials 54, for a second time, are actively separated using nozzles 533 and are brought to the conveyor belt 535. The plastics on the conveyor belt 535 separated here also reach the collection point where the sorting process for this material continues in the sorting system 6 with the segregation of PE material.

This double sorting process following uniform sorting criteria ensures that the remaining plastics are largely _{“}clean”. Should it be necessary to clean the material further it would be recommended to once more actively eject all plastic parts of the desired material in a subsequent sorting device not shown below.

Usually the active ejection of the desired material is used to sort the material according to color criteria in several consecutive sorting steps.

This sorting could usefully begin by sorting out all transparent plastic parts of a material in an initial step and then separating all remaining plastic parts according to certain colors. Usually only those plastic parts in the plastic flow that do not reflect any rays, namely very dark or black plastic, remain.

The PET material in the clean plastic flow still remaining at the exit of the sorting system 5 is isolated again in order to execute the above described second process step in the next sorting system 56/57 via another distribution channel 561 and led to the conveyor belt of a sorting device 562, where the natural colored or transparent PET materials 563 are actively separated from the other colored (573) and black (572) PET materials. The natural colored or transparent PET materials (563) can immediately be identified in a container and later be prepared for further processing.

In the flow of the colored PET materials, plastic parts of different colors can still be actively segregated either alone or together (for example 573). The parts of the material 572 contained in the remaining flow are mostly black parts that could not be identified by the sensors of a sorting device 562 and 571.

The _{“}non-PET” materials 54 actively segregated in the first sorting system 5 are isolated again in another sorting system 6 via a distribution channel 61 and are supplied to a sorting device 62, 63, for example for the segregation of the PE material 64.

This sorting system 6, like sorting system 5, consists of two sorting devices 62, 63 placed in rows next to each other which each actively segregate the plastic parts belonging to the _{“}non-PE” material 65 via the ejector nozzles (analog 523, 533).

In the plastic flow led through this sorting system 6 only those parts that belong to the PE material remains. They are identified in bins or containers 64, 64′ and are supplied to either a mill or a bale press.

The plastic parts actively segregated in this sorting system 6 that do not belong to the PE material are separated from the materials that do not belong to the PP material. The PP material actively removed here is stored in the container 71. From the material remaining in the plastic flow that may contain polystyrene (PS), PVC and other materials, another plastic X can be separated in a further sorting process 8 and stored in a container 81. The remains at this point are collected in the container 91 and are either recycled or disposed of.

The separating scheme of each plastic type described here can also be modified depending on the content of the plastic in the initial mixture. Examples of such installations are shown again in FIGS. 6 and 7.

The plastic flow to be sorted here contains predominantly plastic parts made from PET and PE or similar components. FIG. 6 shows a second dominant variant of the sorting device. Here, all those plastic materials 54 and 65 that do not belong to the PET material group 55 or to the PE material group 64 are actively segregated in an initial sorting system 5′ in two consecutive sorting steps 52′, 53′.

The remaining material (PET/55, 64) is supplied a sorting device 6′ that actively separates the PET material 55 from the PE material 64 in two consecutive corresponding sorting steps 62′, 63′. The remaining PE material is immediately put into a container (64). As described above, the PET material 55 is further sorted according to color criteria in the sorting system 56 and is divided into natural color and differently colored components.

Other plastics are segregated from the material actively segregated in the initial sorting system 5′, which includes the _{“}non-PET” material (54) and the _{“}non-PE” material (65).

In this manner, the PP material 71 is actively segregated in the sorting device 7 and/or some other plastic material X which would be appropriate to recycle is actively segregated in a sorting device 8.

Here too, the remaining material is either recycled further or removed via a container 91.

If the share of the PE material 64 in the plastic mixture is significantly higher than the share of the PET material 65, or another material, it would be recommended to conduct the segregation of plastic types in accordance with the process in FIG. 7.

In an initial sorting system 5′, all the plastic that does not belong to the PE material group 64 is segregated in two similar sorting steps 52″, 53″.

The sorting system 5 takes the segregation of the PET material 55, as described above, through an active segregation of the _{“}non-PET” material 54, only in a later step. The further processing of the PET material 55 occurs in the usual manner, as described, in the sorting system 56 and in the sorting device 57 according to color criteria. The remaining material are collected in the container 91′ and otherwise disposed of.

As is well know so-called PET-G materials exist within the PET material group. Preferably, these materials are treated together with the _{“}non-PET” material because of their special crystal structure. The PET-G material as well as the PP material or a PS or a PVC material can be actively or passively segregated at a later time in a sorting device 8.

Reference List

1 Bale releaser

2 Pre-sorting

3 Sorting device (for cartridges)

7 Sorting device PP/sorting step

4, 4′ Perforator

8 Sorting device X/sorting step

5, 5′ Sorting system PET/process step

11 Buffer/string remover (A)

12 Bale releaser/metering device (D)

6, 6′, 6″ Sorting system PE/process step

21 Metal segregator (M) magnet segregator

22 Drum separator (T)

23 Air separator (W)

24 Buffer memory

31 Cartridge container

41 Knife encasement

42 Guiding channel/steady plate

43 Stripper

44 Feeder

54 _{“}Non-PET” material

55 PET material

56 Sorting system PET—colored/natural/sorting step

57 Sorting system PET—colored

65 _{“}Non-PE” material

71 Container PP/PP material

81 Container X/material X

51, 51′ Distribution channel

52, 52′ Initial sorting device/sorting process step

53, 53′ Second sorting device/sorting process step

111 Collection container (for string)

64, 64′ Container PE/PE material

91, 91′ Remnant collector

61, 61′, 61″ Distribution channel

62, 62′, 62″ Initial sorting device PE/sorting step

63, 63′, 63″ Second sorting device PE/sorting step

211 Container (metal)

221 Fine material container

222 Coarse material container

230 Segregator

231 Light material container

232 Dust container

312 Sensor/camera with photo interpretation using sorting logic (SPS)

313 Ejection flap

314 Cartridge

315 Plastic part

315′ Perforated plastic part

411 Needles/knives

511 Bars

521 Conveyor belt

522 Sensor

523 Ejector nozzle

524 Conveyor belt

531 Conveyor belt

532 Sensor

533 Ejector nozzle

534 Conveyor belt

535 Conveyor belt

561 Distribution channel

562 Sorting device

563 Container PET—natural

571 Sorting device/sorting step

572 Container _{“}Non-PET”

573 Container PET—colored

Key to Plastic Abbreviations: Plastics:

PE Polyethylene

PET Polyethylene terephthalate

PET-G Polyethylene terephthalate with special crystal structure

PP Polypropylene

PS Polystyrene

Installation Devices:

A Feed-in section

B Container/bin

C Segregator

D Dosing feeder

M Metal segregator

P Perforator

S Optomechanical sorting device

T Drum separator

V Distribution channel

W Air separator

1. A process for separating plastics according to type from recycled plastic mixtures, whereby the plastic parts, freed from metals, are moved by conveyor belts as a plastic flow; and the plastic parts to be selected are removed from the plastic flow by at least one optomechanical sorting device including ejectors, and whereby the plastic parts to be selected and their position are determined by optical sensors that include sorting logic similar to the optomechanical sorting device, calculating the time and the duration of the activation of the ejectors in the plastic flow of each selected plastic part, and activation of the identified ejectors to change the path of the selected plastic parts; comprising the steps of:
providing an initial process step where an individually controlled ejector associated with at least one optomechanical sorting device is used to separate plastic parts that do not belong to a group of predominant materials contained in the plastic mixture from the plastic flow; and
providing a second process step related to a secondary plastic flow, wherein a second optomechanical sorting device is used to separate a part of the plastic flow that has different optically identifiable characteristics as the remaining plastic flow.

2. The method according to claim 1, wherein the initial process step is performed with programmed sorting logic in at least two consecutive sorting steps.

3. The method according to claim 1, wherein the plastic parts remaining in the plastic flow after the initial process step are actively separated in at least one additional sorting step based on color.

4. The method according to claim 1, wherein the second process step includes an initial sorting step where at least one additional optomechanical sorting device separates plastic parts that are semi-transparent from those that are transparent based on color.

5. The method according to claim 1, wherein the initial process step includes the step of separating the plastic parts from the plastic mixture, the plastic mixture comprising two substantially equal parts of a first plastic material and a second plastic material;
a step following the initial step wherein one of the materials remaining in the plastic flow are actively separated by two similar consecutive sorting steps.

6. The method according to claim 1, wherein PET and PE are the predominant materials contained in the plastic mixture; and wherein PET is separated from PE by two similar consecutive sorting steps.

7. The method according to claim 1, wherein the plastic flow of isolated plastic parts is freed from cartridges in a supplementary process step.

8. The method according to claim 7, wherein cartridges are identified using optical sensors and are segregated using sorting logic that includes geometric references.

9. The method according to claim 1, wherein plastic parts consisting essentially of hollow articles are perforated and deformed before the initial process step.

10. An installation for separating plastic from recycled plastic mixtures including at least one initial conveyor belt carrying a plastic flow including plastic parts, at least one optomechanical sorting device associated with the conveyor belt;
the optomechanical sorting device comprising optical sensors adapted to identify the plastic parts, selectively activatable ejectors distributed over substantially the entire width of the plastic flow, and program control unit adapted to compare optically identified signals with reference parameters of certain plastics and adapted to control the selectively activatable ejectors;
second conveyor belts for each remaining plastic flow, and third conveyor belts for the actively removed plastic parts, comprising:
a first optomechanical sorting device disposed proximate the first conveyor belt and a second optomechanical sorting device is arranged proximate the second conveyor belt, the first and second optomechanical sorting devices including similar sorting programs, and wherein the second conveyor belt leads to a third sorting device with a sorting program based on color.

11. The installation according to claim 10, further comprising a third optomechanical sorting device adapted to segregate cartridges is disposed proximate the plastic flow.

12. The installation according to claim 11, further comprising a perforator with a compressor disposed between the third optomechanical sorting device that separates cartridges and the first optomechanical sorting device.

13. A method for sorting recycled materials comprising the steps of:
(a) separating metal materials, light materials and dust from plastic materials, the plastic materials forming a plastic flow;
(b) determining a first predominant group of plastic materials comprising first and second types of plastic, and a second group of plastic materials that are not included in the first predominant group of plastic materials;
(c) a first separating step wherein the first predominant group is separated from the second predominant group using at least one optomechanical sorting device including at least one ejector; and
(d) a second separating step wherein the first type of plastic is separated from the second type of plastic using at least one optomechanical sorting device including at least one ejector.

14. The method according to claim 13, wherein the second separating step is based on color.

15. The method according to claim 13, wherein transparent material is separated from semi-transparent material in the second separating step.

16. The method according to claim 13, wherein the second separating step comprises two similar and consecutive sorting steps.

17. The method according to claim 13, wherein the first type of plastic is PET and the second type of plastic is PE.

18. The method according to claim 13, wherein the first separating step is based on geometry.

19. The method according to claim 13, wherein hollow articles are perforated or deformed before the first separating step.

20. A system for separating recycled materials comprising:
a first optomechanical sorting device associated with a first conveyor belt,
the first optomechanical sorting device comprising optical sensors adapted to identify the plastic parts, at least one ejector distributed over a portion of the width of the conveyor belt, a control unit including a first sorting program and adapted to compare optical signals with reference parameters and adapted to control the ejector;
second conveyor belt downstream of the first conveyor belt and a second optomechanical sorting device associated with the second conveyor belt;
the second optomechanical sorting device comprising optical sensors adapted to identify the plastic parts, at least one ejector distributed over a portion of the width of the conveyor belt, a control unit including a second sorting program adapted to compare optical signals with reference parameters and adapted to control the ejector; wherein
the first and second sorting programs are similar.

21. The system according to claim 20, wherein the optomechanical sorting device is responsive to color.

22. The system according to claim 20, further comprising a third optomechanical sorting device, adapted to separate cartridges, disposed upstream of the first optomechanical sorting device.

23. The system according to claim 22, wherein the third optomechanical sorting device is responsive to geometry.

24. The system according to claim 20, further comprising a perforator disposed between the third optomechanical sorting device and the first optomechanical sorting device.
